(19) United States
(12) Patent Application Publication
(10) Pub. No.: US 2024/0247654 A1
(43) Pub. Date: Jul. 25, 2024

(54) Electrically-driven Pump Device, and Method for Controlling Same

(71) Applicant: NTN CORPORATION, Osaka (JP)

(72) Inventors: Naotsugu KITAYAMA, Iwata-shi, Shizuoka (JP); Kazuhiro AOSHIMA, Iwata-shi, Shizuoka (JP)

(21) Appl. No.: 18/577,974

(22) PCT Filed: Jun. 23, 2022
(86) PCT No.: PCT/JP2022/025051

§ 371 Date: Jan. 9, 2024

(30) Foreign Application Priority Data
Jul. 15, 2021 (JP) 2021-117140

(51) Int. Cl. F04B 49/20

(52) U.S. Cl. CPC F04B 49/20; F04B 2203/0201; F04B 2203/0209

(57) ABSTRACT

An electrically-driven oil pump device includes a pump that circulates oil, a motor that drives the pump, a control unit that drives the motor on the basis of the received command rotational speed, a current detection unit that detects a motor current flowing through the motor, and a rotation sensor that detects the rotational speed of the motor. When the current detection unit detects a motor current greater than or equal to a set value that has been set in advance on the basis of the relationship of the motor current with respect to the pressure (hydraulic pressure) of the oil, the control unit outputs a response rotational speed corresponding to the command rotational speed instead of the actual rotational speed detected by the rotation sensor.

### TECHNICAL FIELD

The present disclosure relates to an electrically-driven pump device and a method for controlling the same.

### BACKGROUND ART

Conventionally, an electrically-driven oil pump device is mounted for electrically driving an automatic transmission mechanism of an automobile or the like. As disclosed in, for example, Japanese Patent No. 5275071 (PTL 1), a brushless motor is adopted for the electrically-driven oil pump device from the viewpoint of small size and long life.

### CITATION LIST

### Patent Literature

PTL 1: Japanese Patent No. 5275071

### SUMMARY OF INVENTION

### Technical Problem

The electrically-driven oil pump device described in PTL 1 drives a pump on the basis of a command rotational speed per unit time (hereinafter also simply referred to as command rotational speed in the present disclosure) from a controller of a host system, and returns an actual rotational speed per unit time (hereinafter also simply referred to as actual rotational speed in the present disclosure) of the motor with respect to the command rotational speed to the controller of the host system in order to recognize the state of the pump. Therefore, if the actual rotational speed of the motor is not the same as or close to the command rotational speed, the controller of the host system determines that the motor that drives the pump is abnormal.

However, depending on the configuration of the controller of the host system, the controller controls the command rotational speed of the motor not by measuring a hydraulic pressure directly circulated by the electrically-driven oil pump device but by indirectly measuring the hydraulic pressure, so that the actual rotational speed of the motor may deviate from the command rotational speed. Since the hydraulic pressure generated by the electrically-driven oil pump is not measured, the rotational speed decreases when a load increases, and thus a deviation of the actual rotational speed from the command rotational speed may be generated.

The present disclosure is made to solve the foregoing problem, and an object thereof is to provide: an electrically-driven pump device that is configured to output an actual rotational speed of a motor with respect to a received command rotational speed, the electrically-driven pump device determining that the motor is normal even when a deviation of the actual rotational speed from the command rotational speed occurs, while restricting an output of the motor to an appropriate value: and a method for controlling the electrically-driven pump device.

### Solution to Problem

An electrically-driven pump device according to the present disclosure circulates a medium. The electrically-driven pump device includes: a pump that circulates the medium: a motor that drives the pump: a control unit that drives the motor on the basis of a received command rotational speed: a current detection unit that detects a motor current flowing through the motor: and a rotation detection unit that detects a rotational speed of the motor, in which the control unit sets a set value in advance on the basis of a relationship of the motor current with respect to a pressure of the medium, and outputs a response rotational speed corresponding to the command rotational speed instead of an actual rotational speed detected by the rotation detection unit when the motor current detected by the current detection unit is greater than or equal to the set value.

A method for controlling an electrically-driven pump device according to the present disclosure is a method for controlling an electrically-driven pump device that includes a pump that circulates a medium, a motor that drives the pump, a control unit that drives the motor on the basis of a received command rotational speed, a current detection unit that detects a motor current flowing through the motor, and a rotation detection unit that detects a rotational speed of the motor, the method including: setting a set value in advance on the basis of a relationship of the motor current with respect to a pressure of the medium, and determining whether or not the motor current detected by the current detection unit is greater than or equal to the set value; and outputting a response rotational speed corresponding to the command rotational speed instead of an actual rotational speed detected by the rotation detection unit when the motor current detected by the current detection unit is greater than or equal to the set value.

### Advantageous Effects of Invention

According to the present disclosure, when the motor current detected by the current detection unit is greater than or equal to the set value, a response rotational speed corresponding to the command rotational speed instead of the actual rotational speed detected by the rotation detection unit is output. Therefore, even if the actual rotational speed of the motor deviates from the command rotational speed, the output of the motor can be restricted to an appropriate value.

### BRIEF DESCRIPTION OF DRAWINGS

FIG. 1 is a diagram schematically illustrating the configuration of an oil pump system according to a first embodiment.

FIG. 2 is a diagram for describing a relationship between a command rotational speed and an actual rotational speed of a motor in an electrically-driven oil pump device.

FIG. 3 is a flowchart illustrating a method for controlling the electrically-driven oil pump device according to the first embodiment.

FIG. 4 is a diagram for describing a relationship between a motor current and a hydraulic pressure in the electrically-driven oil pump device.

FIG. 5 is a block diagram illustrating the configuration of the electrically-driven oil pump device according to the first embodiment.

FIG. 6 is a diagram illustrating a signal of a rotational speed output from the electrically-driven oil pump device.

FIG. 7 is a diagram for describing a relationship among a rotational speed of the motor, a motor current, and a motor terminal voltage in the electrically-driven oil pump device.

FIG. 8 is a diagram schematically illustrating the configuration of an oil pump system according to a second embodiment.

FIG. 9 is a diagram for describing a relationship, for each temperature, among a rotational speed of the motor, a motor current, and a motor terminal voltage in an electrically-driven oil pump device.

FIG. 10 is a cross-sectional view of an electrically-driven oil pump according to the present disclosure.

FIG. 11 is a perspective external view of the electrically-driven oil pump according to the present disclosure.

### DESCRIPTION OF EMBODIMENTS

Embodiments of the present disclosure will now be described in detail with reference to the drawings. The same or corresponding parts in the drawings are denoted by the same reference signs, and the description thereof will not be repeated.

### First Embodiment

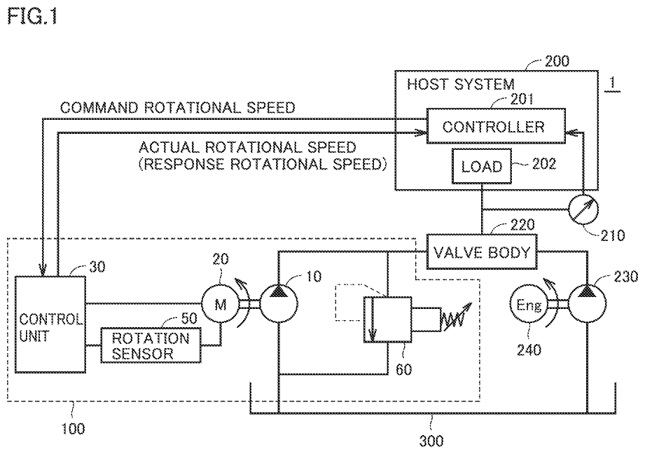

FIG. 1 is a diagram schematically illustrating the configuration of an oil pump system 1 according to a first embodiment. Referring to FIG. 1, oil pump system 1 includes an electrically-driven oil pump device 100, a host system 200, and an oil pan 300.

The present disclosure discloses electrically-driven oil pump device 100 that circulates oil. In particular, electrically-driven oil pump device 100 is for a vehicle-mounted A/T that rotates a motor according to a rotational speed instructed from a controller 201 of host system 200 to supply oil to a transmission.

Note that electrically-driven oil pump device 100 is not limited to be used for a vehicle-mounted A/T, and a medium to be circulated is not limited to oil. The medium to be circulated may be water, air, or the like, and the present disclosure can be applied to any electrically-driven pump device that circulates the medium.

Host system 200 includes controller 201. Controller 201 controls driving of electrically-driven oil pump device 100 by monitoring the hydraulic pressure of a load 202 included in host system 200 with a pressure gauge 210. Controller 201 is, for example, an electronic control unit (ECU) or a programmable logic controller (PLC). Electrically-driven oil pump device 100 and controller 201 are connected by, for example, a signal line of a serial transmission mode. Pressure gauge 210, a valve body 220, and the like as well as electrically-driven oil pump device 100 are connected to controller 201.

Oil pump system 1 includes, in addition to electrically-driven oil pump device 100, a pump 230 for pumping oil from oil pan 300, and an engine 240 for driving pump 230 as illustrated in FIG. 1. Valve body 220 is configured to switch a path connected to host system 200, and connects one of a circulation path on the electrically-driven oil pump device 100 side and a circulation path on the pump 230 side to host system 200. Therefore, the hydraulic pressure measured by pressure gauge 210 provided on host system 200 is the hydraulic pressure of the path connected by valve body 220. That is, when the circulation path on the pump 230 side is connected to host system 200 by valve body 220, controller 201 cannot monitor the hydraulic pressure of electrically-driven oil pump device 100 with the hydraulic pressure measured by pressure gauge 210.

Controller 201 calculates a command rotational speed of electrically-driven oil pump device 100 on the basis of the hydraulic pressure measured by pressure gauge 210, and outputs the command rotational speed to electrically-driven oil pump device 100. Electrically-driven oil pump device 100 controls motor 20 according to the command rotational speed from controller 201. Electrically-driven oil pump device 100 includes a pump 10, motor 20, a control unit 30, a rotation sensor 50, and a relief valve 60.

Pump 10 is, for example, a trochoid pump (internal gear). It is obvious that pump 10 may be a vane, a piston pump, or the like. Rotation sensor 50 detects an actual rotational speed of motor 20. Specifically, rotation sensor 50 is a sensor using a magnetic pole sensor, and detects the rotation of a sensor magnet provided at the end of a rotation shaft of motor 20. Rotation sensor 50 is not limited to the magnetic pole sensor, and may be a sensor obtained by combining a Hall IC and a magnetic pulser ring. Relief valve 60 opens and adjusts the hydraulic pressure when the hydraulic pressure in the circulation path of electrically-driven oil pump device 100 reaches or exceeds a certain level. Relief valve 60 is, for example, a ball valve, a poppet valve, a spool valve, or the like. Although relief valve 60 is disposed inside electrically-driven oil pump device 100, it may be disposed on the side of the system to which electrically-driven oil pump device 100 is connected.

Control unit 30 includes a CPU, a memory, an input interface, and an output interface, and is configured to communicate with controller 201. Control unit 30 receives the command rotational speed of motor 20 from controller 201 through the input interface. The command rotational speed is a target rotational speed for driving motor 20. Controller 201 drives electrically-driven oil pump device 100 on the basis of the command rotational speed. Note that the command rotational speed may be expressed by a command rate of rotation. In addition, the actual rotational speed may be expressed by an actual rate of rotation.

Controller 201 of host system 200 monitors the hydraulic pressure measured by pressure gauge 210, but does not adjust the rotational speed of electrically-driven oil pump device 100 by feedback control of the hydraulic pressure, and sends the rotational speed on the basis of a certain reference (for example, map). Therefore, controller 201 may send a rotational speed more than necessary to electrically-driven oil pump device 100 as the command rotational speed.

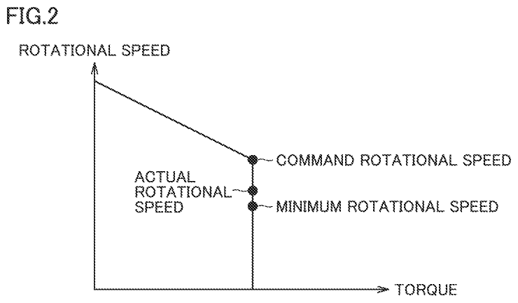

FIG. 2 is a diagram for describing a relationship between the command rotational speed and the actual rotational speed of motor 20 in electrically-driven oil pump device 100. In FIG. 2, the horizontal axis represents torque of motor 20, and the vertical axis represents the rotational speed. Even when the circulation path of electrically-driven oil pump device 100 and the path of pressure gauge 210 are separated, the actual rotational speed of motor 20 is ensured to be greater than or equal to the minimum rotational speed required to obtain a necessary hydraulic pressure as illustrated in FIG. 2.

When maintaining the command rotational speed received from controller 201, electrically-driven oil pump device 100 overdrives pump 10 with respect to the required flow rate, and uses a motor having an output higher than the originally required output, so that the size of the motor is significantly increased. In view of this, in the present embodiment, after it is recognized that there is no abnormality in electrically-driven oil pump device 100, a response rotational speed corresponding to the command rotational speed is output to controller 201 as a dummy instead of the actual rotational speed of motor 20 with respect to the command rotational speed. Electrically-driven oil pump device 100 outputs the dummy response rotational speed to controller 201, thereby avoiding abnormality detection due to a deviation of the actual rotational speed of motor 20 from the command rotational speed.

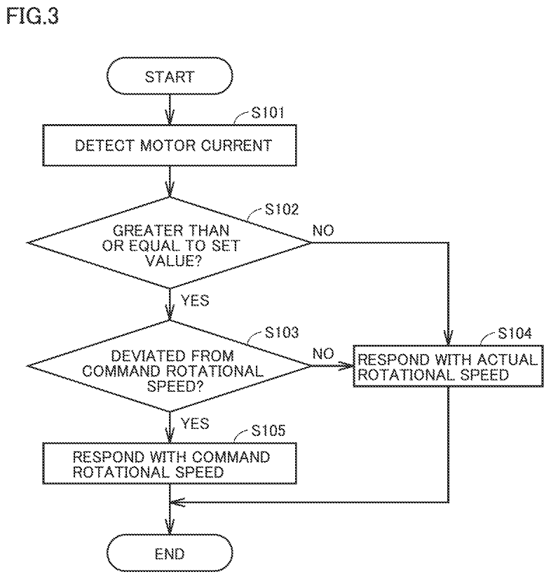

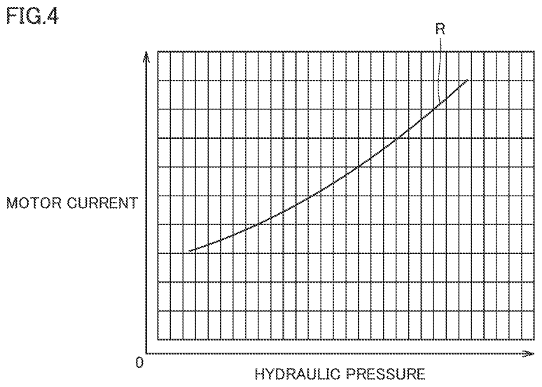

If the actual rotational speed of motor 20 is greater than or equal to than the minimum rotational speed, electrically-driven oil pump device 100 can determine that a necessary hydraulic pressure has been obtained and thus can recognize that there is no abnormality. More preferably, electrically-driven oil pump device 100 determines that the necessary hydraulic pressure has been obtained from the relationship between the motor current and the hydraulic pressure. FIG. 3 is a flowchart illustrating a method for controlling electrically-driven oil pump device 100 according to the first embodiment. FIG. 4 is a diagram for describing a relationship between the motor current and the hydraulic pressure in electrically-driven oil pump device 100.

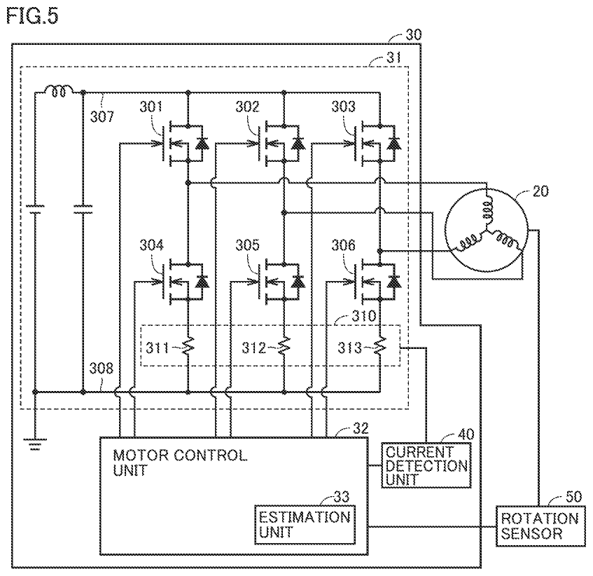

First, control unit 30 detects a motor current (step S101). The motor current may be detected by a current detection element provided on a controller board (inverter circuit) that drives motor 20, or may be estimated from the actual rotational speed, an induced voltage, and the like of motor 20. Examples of the current detection element include a shunt resistor disposed in an inverter circuit. FIG. 5 is a block diagram illustrating the configuration of electrically-driven oil pump device 100 according to the first embodiment. Among the components of electrically-driven oil pump device 100 illustrated in FIG. 5, motor 20, control unit 30, and rotation sensor 50 are illustrated in detail, but pump 10, relief valve 60, and the like are not illustrated.

Motor 20 is a brushless motor including three-phase motor windings. Control unit 30 includes an inverter unit 31, a current detection unit 40, and a motor control unit 32. Inverter unit 31 includes six switching elements 301 to 306 and converts power to the motor windings. Each of switching elements 301 to 306 is a MOSFET, but may be an IGBT, a thyristor, or the like.

Switching element 301 to 303 disposed on a high potential side are connected to an upper bus 307, and switching elements 304 to 306 disposed on a low potential side are connected to a lower bus 308. Current detection unit 310 is provided on the low potential side of inverter unit 31, and current detection elements 311 to 313 are electrically connected to switching elements 304 to 306, respectively. Each of current detection elements 311 to 313 is a shunt resistor. The voltage between both ends of each of current detection elements 311 to 313 is output to motor control unit 32 as a detection value related to a phase current I.

The motor current detected by current detection unit 310 has a relationship indicated as a graph R in FIG. 4 with respect to the hydraulic pressure of electrically-driven oil pump device 100. In FIG. 4, the horizontal axis represents hydraulic pressure, and the vertical axis represents motor current. Based on the relationship of graph R, a value of the motor current at which the hydraulic pressure required by electrically-driven oil pump device 100 is obtained is set in advance as a set value.

Returning to FIG. 3, control unit 30 determines whether or not the motor current detected in step S101 is greater than or equal to the set value (step S102). When the motor current is greater than or equal to the set value (YES in step S102), control unit 30 can recognize that the required hydraulic pressure has been obtained and there is no abnormality. Furthermore, control unit 30 determines whether or not there is a deviation of the input specified rotational speed from the actual rotational speed of motor 20 (step S103). Here, having a deviation of the actual rotational speed of motor 20 from the specified rotational speed means that, for example, the absolute value of the difference between the specified rotational speed and the actual rotational speed of motor 20 is greater than or equal to 20% of the actual rotational speed of motor 20.

When there is no deviation of the actual rotational speed of motor 20 from the input specified rotational speed (NO in step S103) or when the motor current is less than the set value (NO in step S102), control unit 30 outputs the actual rotational speed of motor 20 to controller 201 (step S104).

On the other hand, when there is a deviation of the actual rotational speed of motor 20 from the input specified rotational speed (YES in step S103), control unit 30 outputs a response rotational speed corresponding to the command rotational speed to controller 201 as a dummy (step S105).

In the description of the above-described flowchart, control unit 30 determines whether or not there is a deviation of the actual rotational speed of motor 20 from the input specified rotational speed (step S103) when the motor current is greater than or equal to the set value (YES in step S102). However, control unit 30 may output the dummy response rotational speed to controller 201 (step S105) without determining whether or not there is a deviation of the input specified rotational speed from the actual rotational speed of motor 20, when the motor current is greater than or equal to the set value (YES in step S102).

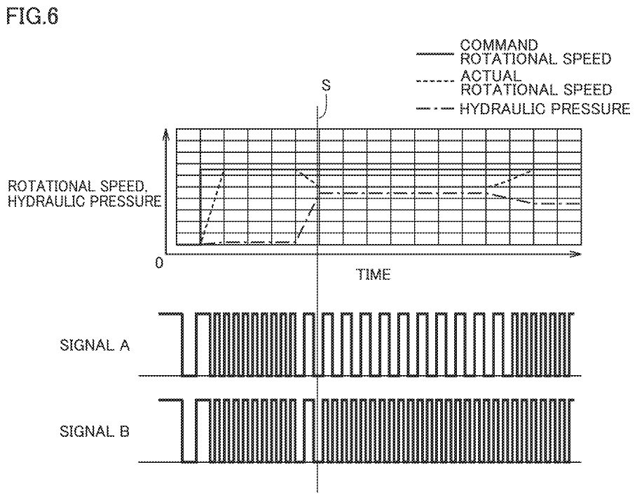

Next, a signal of the rotational speed (command rotational speed) of motor 20 output from control unit 30 to controller 201 will be described. FIG. 6 is a diagram illustrating a signal of the rotational speed output from electrically-driven oil pump device 100. The upper diagram of FIG. 6 illustrates temporal changes of the command rotational speed, the actual rotational speed, and the hydraulic pressure with the horizontal axis representing time and the vertical axis representing the rotational speed or the hydraulic pressure. A solid line graph illustrated in FIG. 6 indicates a temporal change in the command rotational speed from controller 201. A broken line graph illustrated in FIG. 6 indicates a temporal change in the actual rotational speed of motor 20. A dash-dot-dash line graph illustrated in FIG. 6 indicates a temporal change in the hydraulic pressure discharged from pump 10. Signal A is a signal of only the actual rotational speed of motor 20, and signal B is a signal according to the present embodiment and including a dummy response rotational speed. Note that signal A and signal B change in duty ratio in accordance with a change in the rotational speed.

In the upper diagram of FIG. 6, when the motor current reaches or exceeds the set value and the necessary hydraulic pressure is obtained at the timing of time S, a deviation of the actual rotational speed of motor 20 from the command rotational speed occurs. Therefore, control unit 30 does not output a signal having a small duty ratio corresponding to the actual rotational speed of motor 20 as in signal A, but outputs a signal having a large duty ratio corresponding to the command rotational speed as in signal B.

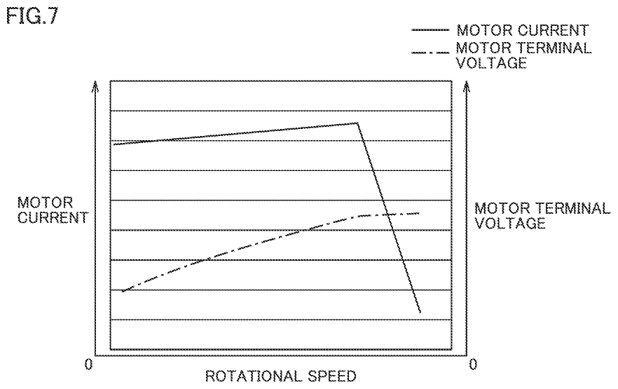

In addition, although the actual rotational speed of motor 20 is detected using rotation sensor 50 in the above description, the actual rotational speed may be calculated using an induced voltage, a motor terminal voltage, or the like of motor 20. FIG. 7 is a diagram for describing a relationship among the rotational speed of motor 20, a motor current, and a motor terminal voltage in electrically-driven oil pump device 100. In FIG. 7, the horizontal axis represents the rotational speed of motor 20, the left vertical axis represents the motor current, and the right vertical axis represents the motor terminal voltage. A solid line graph illustrated in FIG. 7 indicates a relationship between the rotational speed of motor 20 and the motor current. A dash-dot-dash line graph illustrated in FIG. 7 indicates a relationship between the rotational speed of motor 20 and the motor terminal voltage. Note that the rotational speed of motor 20 is the rotational speed of motor 20, and may be expressed by a rate of rotation of motor 20.

Motor control unit 32 illustrated in FIG. 5 includes, for example, an estimation unit 33 that estimates the rotational speed of motor 20 on the basis of the motor terminal voltage. Estimation unit 33 stores in advance the data of the dash-dot-dash line graph illustrated in FIG. 7, and estimates the rotational speed of motor 20 on the basis of the data and the motor terminal voltage that can be acquired from inverter unit 31.

Electrically-driven oil pump device 100 is not limited to have either estimation unit 33 or rotation sensor 50, and may redundantly have both estimation unit 33 and rotation sensor 50. When having both estimation unit 33 and rotation sensor 50, electrically-driven oil pump device 100 may compare the rotational speed (estimated rotational speed) of motor 20 estimated by estimation unit 33 with the rotational speed of motor 20 detected by rotation sensor 50, and determine that some abnormality has occurred in a case where a difference between them is greater than or equal to a predetermined value (for example, 10%). Further, electrically-driven oil pump device 100 may impose a limitation so that the dummy response rotational speed is not output to controller 201 when the difference between them is greater than or equal to the predetermined value.

Further, although electrically-driven oil pump device 100 is provided with relief valve 60 in the above description, electrically-driven oil pump device 100 may not be provided with relief valve 60. Due to having relief valve 60, electrically-driven oil pump device 100 can mechanically determine that the hydraulic pressure is excessive beyond an upper limit value, and thus, having relief valve 60 is advantageous from the viewpoint of reliability. However, since electrically-driven oil pump device 100 can determine whether or not the hydraulic pressure is excessive with respect to the necessary hydraulic pressure from the motor current, relief valve 60 may be eliminated, which can reduce cost.

As described above, electrically-driven oil pump device 100 according to the first embodiment is an electrically-driven pump device that circulates oil (medium). Electrically-driven oil pump device 100 includes pump 10 that circulates oil, motor 20 that drives pump 10, control unit 30 that drives motor 20 on the basis of the received command rotational speed, current detection unit 40 that detects a motor current flowing through motor 20, and rotation sensor 50 that detects the rotational speed of motor 20. control unit 30 sets a set value in advance on the basis of the relationship of the motor current with respect to the pressure (hydraulic pressure) of the oil, and outputs a response rotational speed corresponding to the command rotational speed instead of the actual rotational speed detected by rotation sensor 50 when the motor current detected by the current detection unit 40 is greater than or equal to the set value.

Thus, when the motor current detected by current detection unit 40 is greater than or equal to the set value, electrically-driven oil pump device 100 according to the first embodiment outputs the response rotational speed corresponding to the command rotational speed instead of the actual rotational speed detected by rotation sensor 50. Therefore, even if the actual rotational speed of the motor deviates from the command rotational speed, the output of the motor can be restricted to an appropriate value. Accordingly, electrically-driven oil pump device 100 can avoid a situation in which controller 201 requires motor 20 to excessively output in order to bring the actual rotational speed of motor 20 close to the command rotational speed, and thus, motor 20 can be downsized.

Preferably, control unit 30 determines whether or not the deviation of the actual rotational speed from the command rotational speed is greater than or equal to a predetermined value when the motor current detected by current detection unit 40 is greater than or equal to the set value, and outputs the response rotational speed instead of the actual rotational speed when the deviation is greater than or equal to the predetermined value. With this configuration, electrically-driven oil pump device 100 can output the response rotational speed only when the deviation of the actual rotational speed from the command rotational speed is large.

Preferably, control unit 30 receives the command rotational speed from controller 201 that controls oil pump system 1 including electrically-driven oil pump device 100, and outputs the actual rotational speed or the response rotational speed to controller 201 as a response to the command rotational speed. With this configuration, electrically-driven oil pump device 100 can avoid a situation in which controller 201 requires motor 20 to excessively output in order to bring the actual rotational speed of motor 20 close to the command rotational speed.

Preferably, current detection unit 40 includes a shunt resistor that detects the motor current flowing through motor 20. With this configuration, electrically-driven oil pump device 100 can easily detect the motor current.

Preferably, a rotation detection unit includes at least one of rotation sensor 50 that detects the rotational speed of motor 20 or estimation unit 33 that estimates the rotational speed of motor 20 on the basis of the induced voltage or the motor terminal voltage of motor 20. With this configuration, electrically-driven oil pump device 100 can easily obtain the rotational speed of motor 20.

Preferably, the rotation detection unit includes rotation sensor 50 that detects the rotational speed of motor 20 and estimation unit 33 that estimates the rotational speed of motor 20 on the basis of the induced voltage or the motor terminal voltage of motor 20, and control unit 30 determines that a rotation abnormality occurs and does not output the response rotational speed when the difference between the rotational speed of motor 20 detected by rotation sensor 50 and the estimated rotational speed of the motor estimated by estimation unit 33 is greater than or equal to a predetermined value. With this configuration, electrically-driven oil pump device 100 can detect an abnormality of motor 20 and can impose a limitation so that the dummy response rotational speed is not output when motor 20 is abnormal.

It is preferable that relief valve 60 that adjusts the pressure of the oil is further provided. With this configuration, electrically-driven oil pump device 100 can mechanically determine that the hydraulic pressure is excessive beyond an upper limit value, and thus, reliability is improved.

A method for controlling electrically-driven oil pump device 100 includes: setting a set value in advance on the basis of the relationship of the motor current with respect to the pressure (hydraulic pressure) of the oil, and determining whether or not current detection unit 40 detects a motor current greater than or equal to the set value; and outputting a response rotational speed corresponding to the command rotational speed instead of the actual rotational speed detected by rotation sensor 50 when the motor current detected by current detection unit 40 is greater than or equal to the set value. Thus, according to the method for controlling electrically-driven oil pump device 100 according to the first embodiment, when the motor current detected by current detection unit 40 is greater than or equal to the set value, the response rotational speed corresponding to the command rotational speed is output instead of the actual rotational speed detected by rotation sensor 50. Therefore, even if the actual rotational speed of the motor deviates from the command rotational speed, the output of the motor can be restricted to an appropriate value.

### Second Embodiment

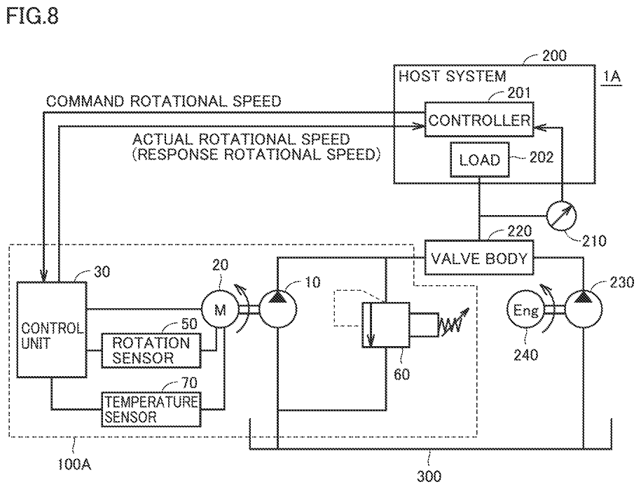

The oil circulated by an electrically-driven oil pump device changes in viscosity under the influence of temperature. In view of this, the second embodiment will describe an electrically-driven oil pump device that performs control in consideration of temperature. FIG. 8 is a diagram schematically illustrating the configuration of an oil pump system 1A according to the second embodiment. Oil pump system 1A includes an electrically-driven oil pump device 100A, a host system 200, and an oil pan 300. Electrically-driven oil pump device 100A includes a temperature sensor 70 that detects the temperature of motor 2.

Electrically-driven oil pump device 100A has the same configuration as electrically-driven oil pump device 100 illustrated in FIG. 1 except that temperature sensor 70 is provided. Oil pump system 1A has the same configuration as oil pump system 1 illustrated in FIG. 1 except that oil pump system 1A includes electrically-driven oil pump device 100A including temperature sensor 70. Therefore, in electrically-driven oil pump device 100A and oil pump system 1A illustrated in FIG. 8, the same components as those of electrically-driven oil pump device 100 and oil pump system 1 illustrated in FIG. 1 are denoted by the same reference numerals, and the detailed description thereof will not be repeated.

Temperature sensor 70 detects the temperature of motor 20 and outputs the temperature to control unit 30. Control unit 30 determines whether or not to output a dummy response rotational speed instead of the actual rotational speed of motor 20 in consideration of the temperature detected by temperature sensor 70. Specifically, control unit 30 changes the set value for determining the motor current in consideration of the temperature detected by temperature sensor 70. Although temperature sensor 70 that detects the temperature of motor 20 will be described as an example, the temperature sensor may be a sensor that detects the temperature of another place such as a circuit board that controls motor 20.

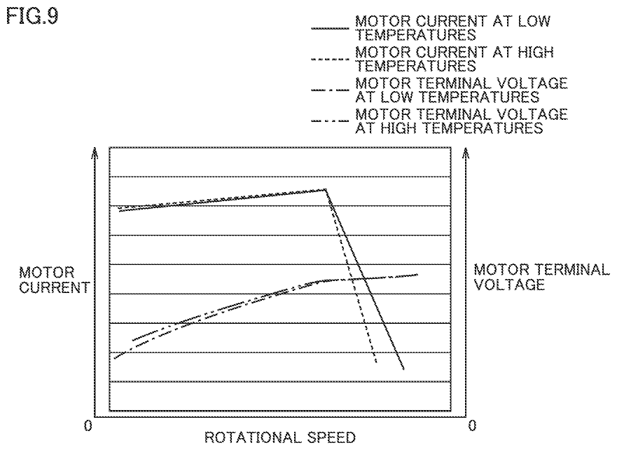

FIG. 9 is a diagram for describing a relationship, for each temperature, among the rotational speed of motor 20, a motor current, and a motor terminal voltage in electrically-driven oil pump device 100A. In FIG. 9, the horizontal axis represents the rotational speed of motor 20, the left vertical axis represents the motor current, and the right vertical axis represents the motor terminal voltage. A solid line graph illustrated in FIG. 9 indicates a relationship between the rotational speed of motor 20 and the motor current at low temperatures. A broken line graph illustrated in FIG. 9 indicates a relationship between the rotational speed of motor 20 and the motor current at high temperatures. A dash-dot-dash line graph illustrated in FIG. 9 indicates a relationship between the rotational speed of motor 20 and the motor terminal voltage at low temperatures. A dash-dot-dot-dash line graph illustrated in FIG. 9 indicates a relationship between the rotational speed of motor 20 and the motor terminal voltage at high temperatures.

When the temperature detected by temperature sensor 70 is greater than or equal to a predetermined temperature, control unit 30 determines that the temperature is high, corrects the relationship between the motor current and the hydraulic pressure illustrated in FIG. 4 on the basis of the broken line graph indicating the relationship between the rotational speed of motor 20 and the motor current at high temperatures illustrated in FIG. 9, and determines the set value. When the temperature detected by temperature sensor 70 is less than the predetermined temperature, control unit 30 determines that the temperature is low, corrects the relationship between the motor current and the hydraulic pressure illustrated in FIG. 4 on the basis of the solid line graph indicating the relationship between the rotational speed of motor 20 and the motor current at low temperatures illustrated in FIG. 9, and determines the set value.

As a result, control unit 30 can determine whether or not to output the dummy response rotational speed instead of the actual rotational speed of motor 20 with the set value at high temperatures when the temperature is high and with the set value at low temperatures when the temperature is low, in consideration of the temperature detected by temperature sensor 70.

Furthermore, estimation unit 33 illustrated in FIG. 5 estimates the rotational speed of motor 20 in consideration of the temperature detected by temperature sensor 70. Specifically, when the temperature detected by temperature sensor 70 is greater than or equal to a predetermined temperature, estimation unit 33 determines that the temperature is high, and estimates the rotational speed of motor 20 on the basis of the dash-dot-dot-dash line graph indicating the relationship between the rotational speed of motor 20 and the motor terminal voltage at high temperatures illustrated in FIG. 9. When the temperature detected by temperature sensor 70 is less than the predetermined temperature, estimation unit 33 determines that the temperature is low, and estimates the rotational speed of motor 20 on the basis of the dash-dot-dash line graph indicating the relationship between the rotational speed of motor 20 and the motor terminal voltage at low temperatures illustrated in FIG. 9.

As a result, estimation unit 33 can accurately estimate the actual rotational speed of motor 20 on the basis of the graph at high temperatures when the temperature is high and on the basis of the graph at low temperatures when the temperature is low, in consideration of the temperature detected by temperature sensor 70. It is obvious that, if the graph indicating the relationship between the rotational speed of motor 20 and the induced voltage of motor 20 in consideration of temperatures is stored in advance, estimation unit 33 can accurately estimate the actual rotational speed of motor 20 on the basis of the temperature detected by temperature sensor 70 and the induced voltage of motor 20.

As described above, electrically-driven oil pump device 100A according to the second embodiment further includes temperature sensor 70 (temperature detection unit) that detects the temperature of motor 20, and control unit 30 determines whether or not to output the dummy response rotational speed instead of the actual rotational speed of motor 20 in consideration of the temperature detected by temperature sensor 70. Thus, electrically-driven oil pump device 100A according to the second embodiment can determine the actual hydraulic pressure state by considering the temperature detected by temperature sensor 70 and output the dummy response rotational speed.

### <Electrically-Driven Oil Pump Device>

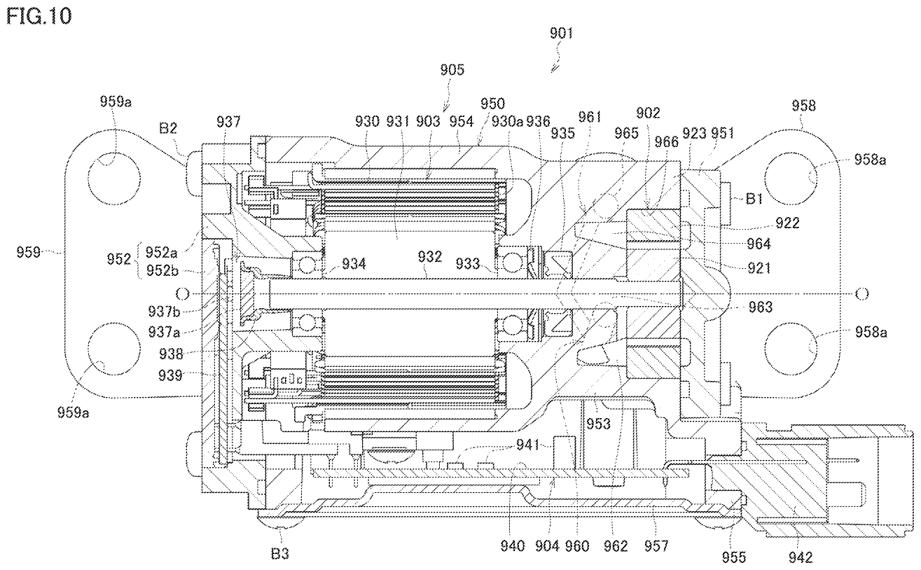

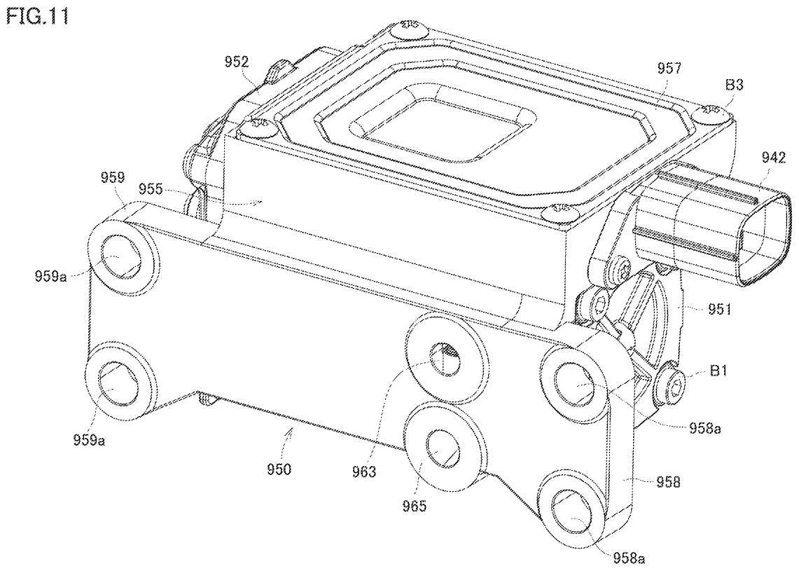

The configuration of electrically-driven oil pump device 100 or electrically-driven oil pump device 100A will be described in detail. FIG. 10 is a cross-sectional view of an electrically-driven oil pump 901 according to the present disclosure. FIG. 11 is a perspective external view of electrically-driven oil pump 901 according to the present disclosure. Electrically-driven oil pump 901 described below corresponds to electrically-driven oil pump device 100 or electrically-driven oil pump device 100A. A pump portion 902 corresponds to pump 10, a motor portion 903 corresponds to motor 20, and a controller 904 corresponds to control unit 30.

Electrically-driven oil pump 901 according to the present disclosure is an electrically-driven oil pump that supplies a hydraulic pressure to a transmission mainly while an engine is stopped. Electrically-driven oil pump 901 sucks oil from an oil reservoir at the bottom of a transmission case, discharges the oil, and pumps the oil into the transmission. Thus, a hydraulic pressure and amount of lubricating oil necessary in the transmission can be ensured.

As illustrated in FIG. 10, electrically-driven oil pump 901 according to the present disclosure includes pump portion 902 that generates a hydraulic pressure, motor portion 903 that drives pump portion 902, controller 904 (main board) provided with a control circuit that controls motor portion 903, and a housing 905 that accommodates pump portion 902, motor portion 903, and controller 904. Each member or element will be described in detail below.

In the following description, a direction parallel to an axis O of motor portion 903 is referred to as “axial direction”, and a radial direction of a circle with axis O as a center is referred to as “radial direction” (“inner diameter direction” and “outer diameter direction” also mean an inner diameter direction and an outer diameter direction of the circle). A circumferential direction of the circle with axis O as a center is referred to as “circumferential direction”.

As illustrated in FIG. 10, pump portion 902 according to the present disclosure is a rotary pump that rotates to pump oil. Specifically, pump portion 902 is a trochoid pump including an inner rotor 921 provided with a plurality of external teeth, an outer rotor 922 provided with a plurality of internal teeth, and a pump case 923 as a stationary member that houses inner rotor 921 and outer rotor 922. Inner rotor 921 is disposed on the inner diameter side of outer rotor 922. Outer rotor 922 is located at a position eccentric to inner rotor 921. A part of a tooth portion of outer rotor 922 meshes with a part of a tooth portion of inner rotor 921. When the number of teeth of inner rotor 921 is n, the number of teeth of outer rotor 922 is (n+1). Both the outer peripheral surface of outer rotor 922 and the inner peripheral surface of pump case 923 are cylindrical surfaces that can be fitted to each other. Outer rotor 922 is rotatably disposed on the inner periphery of pump case 923 so as to be rotationally driven with the rotation of inner rotor 921.

As illustrated in FIG. 10, motor portion 903 is arranged side by side with pump portion 902 in the axial direction. As motor portion 903, a three-phase brushless DC motor, for example, is used. Motor portion 903 includes a stator 930 having a plurality of coils 930a, a rotor 931 disposed inside stator 930 with a gap, and an output shaft 932 coupled to rotor 931. Coils 930a corresponding to three phases of a U phase, a V phase, and a W phase are formed in stator 930.

Output shaft 932 is supported so as to be rotatable with respect to housing 905 via bearings 933 and 934. Inner rotor 921 of pump portion 902 is attached to an end of output shaft 932 on the pump portion 902 side. A speed reducer is not disposed between output shaft 932 and pump portion 902. Inner rotor 921 is fitted to output shaft 932 of motor portion 903, and power can be transmitted by, for example, a width across flats. A seal 935 including a seal lip in sliding contact with the outer peripheral surface of output shaft 932 is disposed between bearing 933 located on the pump portion 902 side in the axial direction and inner rotor 921. Seal 935 prevents leakage of oil from pump portion 902 to motor portion 903. An elastic member 936 compressed in the axial direction is disposed between bearing 933 on the pump portion 902 side in the axial direction and seal 935, and applies preload to bearings 933 and 934.

In order to detect the rotation angle of rotor 931 in motor portion 903, a detection unit 937 is provided between the rotation side and the stationary side of motor portion 903. Detection unit 937 according to the present disclosure can include a sensor magnet 937a (for example, a neodymium bonded magnet) attached to a shaft end of output shaft 932 on the side opposite to the pump portion via a bracket 938, and a magnetic sensor 937b such as an MR element provided in housing 905 that is the stationary side. Magnetic sensor 937b is attached to a sub board 939 that is disposed to face the shaft end of output shaft 932 on the side opposite to the pump portion and is disposed in the direction orthogonal to output shaft 932. A detection value of magnetic sensor 937b is input to the control circuit of controller 904 (main board) described later.

Note that a Hall element can also be used as magnetic sensor 937b. In addition to the magnetic sensor, an optical encoder, a resolver, or the like can also be used as detection unit 937. Note that motor portion 903 can be driven without a sensor.

Controller 904 according to the present disclosure is disposed in parallel with output shaft 932 of motor portion 903. A plurality of electronic components 941 is mounted on controller 904. These electronic components 941 constitute the control circuit that controls driving of motor portion 903. In the illustrated example, controller 904 is disposed such that a surface (mounting surface) 940 on which electronic components 941 are mounted faces pump portion 902 and motor portion 903. Power is supplied from an external power supply to controller 904 via a connector 942.

Housing 905 includes a cylindrical housing body 950 having both ends opened, a first lid portion 951 that closes an opening of housing body 950 on the pump side in the axial direction, and a second lid portion 952 that closes an opening of housing body 950 on the side opposite to the pump in the axial direction. First lid portion 951 and second lid portion 952 are fixed to housing body 950 using a plurality of fastening bolts B1 and B2, respectively.

Second lid portion 952 includes a cylindrical bearing case 952a that supports bearing 934 on the side opposite to the pump portion, and a cover 952b that closes the opening of bearing case 952a on the side opposite to the pump portion. Sub board 939 is disposed on the inner diameter side of bearing case 952a. Cover 952b is attached to bearing case 952a using a fastening member (not illustrated).

Housing body 950 includes a pump housing portion 953 that houses pump portion 902, a motor housing portion 954 that houses motor portion 903, and a controller housing portion 955 that houses controller 904. Housing body 950 is integrally formed in a form of a single component by, for example, casting, cutting, or a combination thereof. Housing body 950, first lid portion 951, and second lid portion 952 are conductors and are formed of a metal material having excellent thermal conductivity, for example, an aluminum alloy. Alternatively, one or more of housing body 950, first lid portion 951, and second lid portion 952 may be formed of another metal material (for example, iron-based metal) or resin.

Pump housing portion 953 of housing 905 has a substantially cylindrical shape including pump case 923 of pump portion 902. Pump housing portion 953 has a pump chamber 966 in which inner rotor 921 and outer rotor 922 are housed, an inlet port 962, and a discharge port 964. Both inlet port 962 and discharge port 964 are provided adjacent to the motor portion 903 side (left side in FIG. 10) of pump chamber 966, and open to a meshing portion between inner rotor 921 and outer rotor 922. Inlet port 962 and discharge port 964 both have an arc shape extending in the circumferential direction of output shaft 932, and are provided at positions facing each other at 180° in the circumferential direction.

Motor housing portion 954 of housing 905 is formed in a cylindrical shape. Stator 930 of motor portion 903 is press-fitted or adhesively fixed to the cylindrical inner peripheral surface of motor housing portion 954. The outer diameter side (lower side in FIG. 10) of controller housing portion 955 of housing 905 in the radial direction is opened, and the opening portion is closed by a cover 957 after controller 904 is housed in controller housing portion 955. Cover 957 is attached to housing body 950 using a fastening member B3.

As illustrated in FIGS. 10 and 11, flange-shaped mounting portions 958 and 959 for mounting electrically-driven oil pump 901 to a component to which electrically-driven oil pump 901 is to be mounted (a transmission case in the present disclosure) are integrally formed on both sides of housing body 950 in the axial direction. Two fastening holes 958a are formed in mounting portion 958 on the pump portion 902 side, and two fastening holes 959a are formed in mounting portion 959 on the side opposite to the pump portion. Fastening members (not illustrated) are inserted into fastening holes 958a and 959a, and the fastening members are screwed into the transmission case, whereby electrically-driven oil pump 901 is mounted to the transmission case.

As illustrated in FIG. 10, housing body 950 is provided with inlet pipeline 960 through which the oil to be supplied to pump portion 902 flows and a discharge pipeline 961 through which the oil discharged from pump portion 902 flows. One end of inlet pipeline 960 is connected to inlet port 962. The other end of inlet pipeline 960 opens to the surface of housing body 950, and this opening serves as an inlet opening 963. One end of discharge pipeline 961 is connected to discharge port 964. The other end of discharge pipeline 961 opens to the surface of housing body 950, and this opening serves as a discharge opening 965. Inlet opening 963 and discharge opening 965 are provided in a surface of housing 905 facing the transmission case. Thus, it is not necessary to route an oil pipe around electrically-driven oil pump 901, and the peripheral structure of electrically-driven oil pump 901 can be simplified.

In electrically-driven oil pump 901, inlet opening 963 and discharge opening 965 are provided in the surface of housing body 950. In addition, both inlet pipeline 960 connecting inlet opening 963 and pump portion 902 and discharge pipeline 961 connecting discharge opening 965 and pump portion 902 are provided in housing body 950. Therefore, housing body 950 can be cooled by the oil flowing through inlet pipeline 960 and discharge pipeline 961. With this cooling effect, it is possible to promote cooling of motor portion 903 and controller 904 serving as a heat source, whereby reliability of electrically-driven oil pump 901 can be improved. In addition, electrically-driven oil pump 901 can be downsized as compared with a case where inlet pipeline 960 and discharge pipeline 961 are provided in a member different from housing body 950.

It is also possible to use inlet pipeline 960 as a discharge pipeline and discharge pipeline 961 as an inlet pipeline without changing the configurations of inlet pipeline 960 and discharge pipeline 961. Further, both inlet pipeline 960 and discharge pipeline 961 may be disposed in a region between pump portion 902 and motor portion 903 in the axial direction, or either one may be disposed in a region (for example, a region on the outer diameter side of motor portion 903) other than the abovementioned region.

### <First Modification>

The above-described embodiment has described the configuration in which electrically-driven oil pump device 100, 100A outputs the dummy response rotational speed instead of the actual rotational speed of motor 20 to controller 201. However, controller 201 cannot identify whether the input rotational speed is the actual rotational speed or the dummy rotational speed based on information including only the actual rotational speed and information including only the dummy response rotational speed of motor 20. In view of this, electrically-driven oil pump device 100, 100A may output the dummy response rotational speed to controller 201 so as to be distinguishable from the actual rotational speed of motor 20.

Specifically, when the rotational speed to be output to controller 201 is signal B illustrated in FIG. 6, control unit 30 changes the duty ratio, the frequency, and the like of the signal of the dummy response rotational speed with respect to the signal of the actual rotational speed, and outputs the resultant signal to controller 201. In addition, control unit 30 may add information such as a flag to the signal of the dummy response rotational speed in order to distinguish the signal of the dummy response rotational speed from the signal of the actual rotational speed.

control unit 30 preferably uses a signal by which the response rotational speed can be distinguished from the actual rotational speed. As a result, controller 201 can recognize the state where the electrically-driven oil pump device suppresses the rotational speed of motor 20.

### <Second Modification>

In the above-described embodiment, controller 201 drives electrically-driven oil pump device 100 or electrically-driven oil pump device 100A on the basis of the command rotational speed. Therefore, the above embodiment has described the configuration in which, even when control unit 30 notifies controller 201 of the rotational speed of motor 20, controller 201 does not perform the feedback control based on the notified rotational speed of motor 20. However, controller 201 may perform the feedback control by receiving the actual rotational speed of motor 20 back from the output interface of control unit 30.

Note that control unit 30 drives motor 20 on the basis of the command rotational speed, and if a necessary hydraulic pressure can be obtained even when a deviation of the actual rotational speed of motor 20 from the command rotational speed occurs, the determination indicating that abnormality occurs can be avoided.

### <Third Modification>

Although the above-described embodiment has described the configuration in which electrically-driven oil pump device 100 or electrically-driven oil pump device 100A drives pump 10 by motor 20, a pump that is not driven by the motor may be used. In this case, the present disclosure can be applied by replacing the command rotational speed for the motor with a command value for driving the pump and replacing the actual rotational speed of the motor with a value related to driving of the pump.

The embodiments and modifications disclosed herein are to be considered in all respects as illustrative and not restrictive. The scope of the present invention is indicated by the appended claims rather than by the foregoing descriptions, and is intended to include all modifications within the meanings and ranges equivalent to the claims.

### REFERENCE SIGNS LIST

1, 1A: oil pump system, 20: motor, 10, 230: pump, 30: control unit, 31: inverter unit, 32: motor control unit, 33: estimation unit, 40, 310: current detection unit, 50: rotation sensor, 60: relief valve, 70: temperature sensor, 100, 100A: electrically-driven oil pump device, 200: host controller, 210: pressure gauge, 220: valve body, 240: engine, 300: oil pan, 901: electrically-driven oil pump, 902: pump portion, 903: motor portion, 905: housing, 921: inner rotor, 922: outer rotor, 923: pump case, 930: stator, 930a: coil, 931: rotor, 932: output shaft, 933, 934: bearing, 935: seal, 936: elastic member, 937: detection unit, 937a: sensor magnet, 937b: magnetic sensor, 938: bracket, 939: sub board, 941: electronic component, 942: connector, 950: housing body, 951: first lid portion, 952: second lid portion, 952a: bearing case, 952b, 957: cover, 953: pump housing portion, 954: motor housing portion, 955: controller housing portion, 958, 959: mounting portion, 958a, 959a: fastening hole, 960: inlet pipeline, 961: discharge pipeline, 962: inlet port, 963: inlet opening, 964: discharge port, 965: discharge opening, 966: pump chamber

1. An electrically-driven pump device that circulates a medium, the electrically-driven pump device comprising:
a pump that circulates the medium;
a motor that drives the pump;
a control unit that drives the motor on the basis of a received command rotational speed;
a current detection unit that detects a motor current flowing through the motor; and
a rotation detection unit that detects a rotational speed of the motor,
wherein the control unit sets a set value in advance on the basis of a relationship of the motor current with respect to a pressure of the medium, and outputs a response rotational speed corresponding to the command rotational speed instead of an actual rotational speed detected by the rotation detection unit when the motor current detected by the current detection unit is greater than or equal to the set value.

2. The electrically-driven pump device according to claim 1, wherein
the control unit determines whether or not a deviation of the actual rotational speed from the command rotational speed is greater than or equal to a predetermined value when the motor current detected by the current detection unit is greater than or equal to the set value, and
outputs the response rotational speed instead of the actual rotational speed when the deviation is greater than or equal to the predetermined value.

3. The electrically-driven pump device according to claim 1,
wherein
the control unit
receives the command rotational speed from a controller that controls a system including the electrically-driven pump device, and
outputs the actual rotational speed or the response rotational speed to the controller as a response to the command rotational speed.

4. The electrically-driven pump device according to claim 1, wherein the current detection unit includes a shunt resistor for detecting the motor current flowing through the motor.

5. The electrically-driven pump device according to claim 1, further comprising a temperature detection unit that detects a temperature of the motor, wherein the control unit determines whether or not to output the response rotational speed instead of the actual rotational speed, in consideration of the temperature detected by the temperature detection unit.

6. The electrically-driven pump device according to claim 1, wherein the rotation detection unit includes at least one of a sensor that detects the rotational speed of the motor and an estimation unit that estimates the rotational speed of the motor on the basis of an induced voltage or a motor terminal voltage of the motor.

7. The electrically-driven pump device according to claim 1, wherein
the rotation detection unit includes a sensor that detects the rotational speed of the motor and an estimation unit that estimates the rotational speed of the motor on the basis of an induced voltage or a motor terminal voltage of the motor, and
the control unit determines that a rotation abnormality occurs and does not output the response rotational speed when a difference between the rotational speed of the motor detected by the sensor and an estimated rotational speed of the motor estimated by the estimation unit is greater than or equal to a predetermined value.

8. The electrically-driven pump device according to claim 1, further comprising a relief valve that adjusts a pressure of the medium.

9. The electrically-driven pump device according to claim 1, wherein the response rotational speed is set as a signal that is distinguishable from the actual rotational speed.

10. A method for controlling an electrically-driven pump device including a pump that circulates a medium, a motor that drives the pump, a control unit that drives the motor on the basis of a received command rotational speed, a current detection unit that detects a motor current flowing through the motor, and a rotation detection unit that detects a rotational speed of the motor, the method comprising:
setting a set value in advance on the basis of a relationship of the motor current with respect to a pressure of the medium, and determining whether or not the motor current detected by the current detection unit is greater than or equal to the set value; and
outputting a response rotational speed corresponding to the command rotational speed instead of an actual rotational speed detected by the rotation detection unit when the motor current detected by the current detection unit is greater than or equal to the set value.
